(19) United States
(12) Patent Application Publication
(10) Pub. No.: US 2026/0103600 A1
(43) Pub. Date: Apr. 16, 2026

(54) High Structure Acetylene Black, Process for its Production, and Compositions and Uses Thereof

(71) Applicant: Orion Engineered Carbons IP GmbH & Co. KG, Monheim (DE)

(72) Inventors: Ralf Bergsträsser, Elsdorf (DE); Michael Rohde, Alzenau (DE); Ainhoa Noguera, Köln (DE); Frederic Gombert, Chateauneuf les Martigues (FR); Thierry Pages, Aix-en-Provence (FR)

(21) Appl. No.: 19/114,089

(22) PCT Filed: Aug. 29, 2023
(86) PCT No.: PCT/EP2023/073588

§ 371 Date: Mar. 21, 2025

(30) Foreign Application Priority Data
Sep. 23, 2022 (EP) 22197278.9

(51) Int. Cl. C09C 1/54; C08K 3/02; C09C 1/48; H01M 4/62; H01M 4/86

(52) U.S. Cl. CPC C09C 1/54; C08K 3/02; C09C 1/487; H01M 4/625; H01M 4/8673; C01P 2002/72; C01P 2002/82; C01P 2004/51; C01P 2006/12; C01P 2006/19; C01P 2006/40; C01P 2006/80; C01P 2006/90; C08K 2201/001; C08K 2201/006

(57) ABSTRACT

A high structure acetylene black having an oil absorption number (OAN) of 360 mL/100 g or more and a BET surface area in a range from 50 to 200 m2/g is provided. Such high structure carbon black exhibits excellent electrical conductivity and good processing properties. e.g. dispersibility, having superior power to impart electrical and/or thermal conductivity to various materials, rendering it particularly useful for all kinds of applications where high electrical and/or thermal conductivity is desired or beneficial, such as manufacture of electrodes and other components of energy storage and/or conversion devices or electrically and/or heat conductive materials and articles made thereof.

### CROSS-REFERENCE TO RELATED APPLICATIONS

This application is the United States national phase of International Patent Application No. PCT/EP2023/073588 filed Aug. 29, 2023, and claims priority to European Patent Application No. 22197278.9 filed Sep. 23, 2022, the disclosures of which are hereby incorporated by reference in their entireties.

### BACKGROUND OF THE INVENTION

### Field of the Invention

The present invention relates to novel high structure acetylene blacks, their production, compositions comprising the acetylene blacks as well as articles made thereof, and uses and applications of the acetylene black, e.g., for the production of electrodes or other components of energy storage or conversion devices, or in rubber or plastic articles.

### Description of Related Art

Acetylene black is a particular type of carbon black. Acetylene blacks are commonly produced by thermal decomposition of acetylene gas or acetylene-containing hydrocarbon feedstocks forming colloidal carbon black particles and hydrogen at high temperatures, as described for example in J.-B. Donnet et al., “Carbon Black: Science and Technology”, 2^{nd} edition. Other manufacturing processes such as described in U.S. Pat. No. 4,013,759 are based on an incomplete combustion of a hydrocarbon feedstock. Acetylene blacks are generally very pure (carbon content typically above 99 wt. %) and exhibit good intrinsic conductance. These characteristics render acetylene blacks particularly interesting compared to other types of carbon black such as furnace blacks for applications requiring high purity and good electrical or thermal conductivity. They are accordingly widely used e.g. in the production of electrodes, batteries, fuel cells, capacitors or heating elements as well as to provide antistatic, heat dissipative or conductive properties, to for example plastic or rubber materials and articles such as tires and components thereof like tire bladders, cables, conveyor belts, rollers, hoses, floorings, or shoes, or electronic components, paints, inks coatings and adhesives. The available types of acetylene blacks are however limited. Moreover, it can be difficult to uniformly incorporate them in a material, such as a plastic or rubber material, or a liquid carrier medium e.g. in the manufacture of plastic or rubber articles or the preparation of an aqueous or solvent-based composition such as for the manufacture of electrodes, coatings, paints or inks. This can also adversely affect conductance achievable in the resulting acetylene black doped material. There is accordingly a persistent strive and need for acetylene blacks that exhibit enhanced conductance and good processing properties, e.g. dispersibility, having superior power to impart electrical and/or thermal conductivity to various materials, e.g. allowing to achieve a desired level of material conductance at lower concentration of acetylene black, thereby saving costs, ideally without adversely affecting other properties of the acetylene black relevant for the intended application and realizable in a cost-efficient matter using readily available raw materials and equipment.

Accordingly, it is an objective of the present invention to provide an acetylene black which overcomes or alleviates at least some of the above-mentioned deficiencies and limitations of the prior art. Specifically, it is an aim to provide an acetylene black that exhibits enhanced conductance and can efficiently be incorporated into various materials to impart thereto a desired conductance at comparatively low amounts. Such acetylene black should be obtainable in an economic manner without adversely affecting other beneficial properties of acetylene blacks such as high purity.

### SUMMARY OF THE INVENTION

The above objective has been achieved by providing according to the present invention a novel high structure acetylene black described herein.

The acetylene black according to the present invention is characterized by having an oil absorption number (OAN) of 360 mL/100 g or more and a BET surface area in a range from 50 to 200 m²/g.

The present invention also relates to a process for manufacturing the acetylene black of the present invention. The process comprises supplying a hydrocarbon feedstock comprising acetylene to a reactor, supplying an oxygen-containing gas to the reactor, effecting incomplete combustion of the hydrocarbon feedstock comprising acetylene by bringing the hydrocarbon feedstock comprising acetylene in contact with the oxygen-containing gas to thereby cause formation of the acetylene black in the reactor, and recovering the formed acetylene black. The hydrocarbon feedstock comprising acetylene and the oxygen-containing gas are introduced herein into the reactor such that the molar ratio of oxygen to acetylene is in a range from 0.30 to 0.80.

The present invention furthermore relates to compositions comprising the acetylene black material of the present invention disclosed herein, such as electrode compositions and rubber or plastic compositions.

The present invention also relates to articles made from an acetylene black or composition of the present invention, particularly electrodes or other components of energy storage and/or conversion devices as well as rubber or plastic articles. It is also directed towards energy storage and/or conversion devices comprising an electrode or component made from an acetylene black or composition of the present invention.

Moreover, the present invention is directed towards the use of an acetylene black material as disclosed herein as an electrically conductive agent, antistatic agent, thermally conductive agent, reinforcing filler and/or coloring agent, for example for a production of electrodes and other components of energy storage and/or conversion devices such as primary batteries, secondary batteries, fuel cells and capacitors, and/or of plastic articles made of a thermoplastic or thermoset polymer or rubber matrix such as tires or components thereof, wires, cables and sheaths thereof, belts, hoses, shoe soles, rollers, heaters, or bladders, such as tire bladders, heat conductive materials, heat transfer materials, and/or in coatings, paints or inks.

The acetylene blacks according to the present invention exhibit an extraordinarily high intrinsic conductance and are extremely powerful for imparting electrical and/or thermal conductivity to various materials, e.g. allowing to achieve a desired level of material conductance at comparatively low concentrations of acetylene black. They can efficiently be incorporated into materials to provide compositions with good processability and application performance, including e.g. electrode compositions. The acetylene blacks according to the present invention can moreover maintain or even enhance other beneficial properties of acetylene black such as high purity and are obtainable in an economic manner using readily available raw materials and equipment.

These and other optional features and advantages of the present invention will be described in more detail in the following description.

### BRIEF DESCRIPTION OF THE DRAWING

FIG. 1 is a schematic representation of a reactor configured for manufacturing acetylene blacks in accordance with various aspects of the present invention described herein.

### DESCRIPTION OF THE INVENTION

As used herein, the term “comprising” is understood to be open-ended and to not exclude the presence of additional undescribed or unrecited elements, materials, ingredients or method steps etc. The terms “including”, “containing” and like terms are understood to be synonymous with “comprising”. As used herein, the term “consisting of” is understood to exclude the presence of any unspecified element, ingredient or method step etc.

As used herein, the singular form of “a”, “an”, and “the” include plural referents unless the context clearly dictates otherwise.

Unless indicated to the contrary, the numerical parameters and ranges set forth in the following specification and appended claims are approximations. Notwithstanding that the numerical ranges and parameters setting forth the broad scope of the invention are approximations, the numerical values set forth in the specific examples are reported as precisely as possible. Any numerical values, however, contain errors necessarily resulting from the standard deviation in their respective measurement.

Also, it should be understood that any numerical range recited herein is intended to include all subranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g. 1 to 6.3, or 5.5 to 10, or 2.7 to 6.1.

All parts, amounts, concentrations etc. referred to herein are by weight, unless specified otherwise.

As mentioned above, the acetylene black according to the present invention is characterized by having a medium BET surface area, that is a BET surface area in a range from 50 to 200 m²/g. The acetylene black of the present invention can for example have a BET surface area of 50 m²/g or more, such as 60 m²/g or more, or 70 m²/g or more, or 80 m²/g or more, or 90 m²/g or more, or 100 m²/g or more, or 110 m²/g or more, or 120 m²/g or more, or 130 m²/g or more. The acetylene black of the present invention can for example have a BET surface area of 200 m²/g or less, such as 190 m²/g or less, or 180 m²/g or less, or 170 m²/g or less, or 160 m²/g or less, or 150 m²/g or less, or 140 m²/g or less. The BET surface area of the acetylene black of the present invention can be in a range between any of the recited values such as from 50 m²/g to 200 m²/g, or from 60 m²/g to 180 m²/g, or from 80 m²/g to 160 m²/g. Preferably, the acetylene black of the present invention has a BET surface area in a range from 100 to 200 m²/g, more preferably in a range from 120 to 200 m²/g, even more preferably in a range from 130 to 180 m²/g, still more preferably in a range from 130 to 160 m²/g. The “BET surface area” as used herein refers to the BET surface area, which can be measured by nitrogen adsorption according to ASTM D6556-19a, as also used in the examples.

As mentioned above, the acetylene black according to the present invention moreover characteristically has a high structure. In the field of carbon black materials, structure means the degree of fusion of individual primary carbon black particles to form larger aggregates constituted of a plurality of primary carbon black particles. Oil absorption can serve as an indicator of the structure. The acetylene black according to the present invention has accordingly a high oil absorption number (OAN), indicative of the acetylene black's high structure. The acetylene black of the present invention has an oil absorption number (OAN) of 360 mL/100 g or more. The acetylene black of the present invention can for example have an OAN of 370 mL/100 g or more, such as 380 mL/100 g or more, or 390 mL/100 g or more, or 400 mL/100 g or more, or 410 mL/100 g or more. The acetylene black of the present invention can for example have an OAN of up to 600 mL/100 g, such as 550 mL/100 g or less, or 500 mL/100 g or less, or 490 mL/100 g or less, or 480 mL/100 g or less, or 470 mL/100 g or less, or 460 mL/100 g or less, or 450 mL/100 g or less. The OAN of the acetylene black can be in a range between any of the recited values such as from 360 mL/100 g to 600 mL/100 g, or from 380 mL/g to 500 mL/100 g, or more from 410 mL/100 g to 450 mL/100 g. Preferably, the OAN number is in a range from 380 to 500 mL/100 g, more preferably in a range from 410 to 450 mL/100 g. The “oil absorption number (OAN)” as used herein refers to the oil absorption number, which can be measured according to ASTM D2414-19, as also used in the examples.

As mentioned above, the acetylene blacks according to the present invention exhibit a very high intrinsic conductance and can be efficiently incorporated into various materials, being extremely powerful to impart thereto electrical and/or thermal conductivity. Without intending to be bound to any theory, it is believed that the properties of the acetylene blacks of the present invention, such as high structure and moderate specific surface area, may be particularly beneficial for a formation of conductive pathways and networks and promote interactions with respect to more or less polar components such as aqueous or organic solvent-based carrier media, plastic materials or electrolytes.

In addition to the structure and BET surface area described above, the acetylene black of the present invention can have one or more than one or all of the properties described in the following.

The acetylene black according to the present invention can thus for example be characterized by an oil absorption number for compressed samples (COAN) as determined according to ASTM D3493-19a. The COAN can for example be in a range from 30 percent or more (e.g. 40 percent or more) of the OAN value up to the value of the OAN of the acetylene black. The acetylene black can for example have a COAN of 150 mL/100 g or more, such as 170 mL/100 g or more, or 180 mL/100 g or more. The acetylene black can for example have a COAN of 300 mL/100 g or less, such as 250 mL/100 g or less or 200 mL/100 g or less. The COAN of the acetylene black can be in a range between any of the recited values such as from 150 mL/100 g to 300 mL/100 g, or from 170 mL/100 g to 250 mL/100 g.

Moreover, as mentioned above, the acetylene black generally includes aggregates of a plurality of smaller particles, which are referred to as “primary particles”. The aggregates can be for example assemblies of multiple primary acetylene black particles that are fused together at their contact points and cannot be readily separated. The size of the primary particles in the acetylene black can vary. The average primary particle size of the acetylene black material can be determined by TEM image analysis according to ASTM D3849-07. The acetylene black according to the present invention can for example have an average primary particle size of 10 nm or more, such as 12 nm or more, or 14 nm or more, or 16 nm or more, or 18 nm or more. The average primary particle size of the acetylene black according to the present invention can for example be 30 nm or less, such as 28 nm or less, or 26 nm or less, or 24 nm or less. The average primary particle size of the acetylene black of the present invention can be in a range between any of the recited values such as from 10 nm to 30 nm, or from 14 nm to 28 nm, or from 16 nm to 24 nm.

The acetylene black of the present invention can include aggregates that may have an irregular or non-spherical shape. The shape can for example be characterized by an aspect ratio defined as the ratio of the minimum Feret diameter and the maximum Feret diameter. The particles of the pulverulent acetylene black of the present invention can for example have an aspect ratio of less than 0.8 such as less than 0.6, or less than 0.5, or less than 0.3. The aspect ratio can be determined from electron microscope images, averaging over at least 50 particles. An irregular or non-spherical shape of the particles may be beneficial in forming conductive pathways and networks.

In addition or alternatively, the acetylene black according to the present invention can be characterized in terms of void volume. Void volumes can be measured according to ASTM D7854-18a as the compressed volume of a weighed sample of the acetylene black in a cylindrical chamber as a function of pressure exerted by a movable piston. The measurement method is described in the experimental section below in more detail. Void volumes provide means to assess the acetylene black structure at varying levels of density and aggregate reduction. Increasing irregularity and non-sphericity of the aggregates cause resistance to compression and are thereby generally reflected by higher void volume values. Void volumes are typically reported in terms of void volume values obtained at certain mean geometric pressure, such as 50 MPa, 75 MPa or 125 MPa. The acetylene black according to the present invention can for example have a void volume, measured at a mean geometric pressure of 50 MPa, of 60 cm³/100 g or more, such as 70 cm³/100 g or more, or 75 cm³/100 g or more, or 80 cm³/100 g or more. The acetylene black according to the present invention can for example have a void volume, measured at a mean geometric pressure of 50 MPa, of 120 cm³/100 g or less, such as 100 cm³/100 g or less, or 90 cm³/100 g or less. The void volume (@50 MPa) can be in a range between any of the recited values such as from 60 to 120 cm³/100 g, or from 75 to 100 cm³/100 g. In addition or alternatively, the acetylene black according to the present invention can have a void volume, measured at a mean geometric pressure of 75 MPa, of 50 cm³/100 g or more, such as 60 cm³/100 g or more, or 65 cm³/100 g or more. The acetylene black according to the present invention can for example have a void volume, measured at a mean geometric pressure of 75 MPa, of 100 cm³/100 g or less, such as 90 cm³/100 g or less, or 80 cm³/100 g or less. The void volume (@75 MPa) can be in a range between any of the recited values such as from 50 to 100 cm³/100 g, or from 65 to 80 cm³/100 g. Furthermore, in addition or alternatively, the acetylene black according to the present invention can have a void volume, measured at a mean geometric pressure of 125 MPa, of 40 cm³/100 g or more, such as 45 cm³/100 g or more, or 50 cm³/100 g or more. The acetylene black according to the present invention can for example have a void volume, measured at a mean geometric pressure of 125 MPa, of 80 cm³/100 g or less, such as 70 cm³/100 g or less, or 60 cm³/100 g or less. The void volume (@125 MPa) can be in a range between any of the recited values such as from 40 to 80 cm³/100 g, or from 50 to 60 cm³/100 g.

In addition or alternatively, the acetylene black material according to the present invention can be characterized by its aggregate size distribution. The aggregate size distribution can be determined using a disc centrifuge photosedimentometer (DCP) according to ISO 15825:2017. The aggregate size distribution can be described inter alia by the mode value (D_{mode}), i.e. the aggregate diameter with the most frequent occurrence, appearing as a peak in the mass distribution curve. The aggregate size distribution can further be described by the width of the mass distribution curve measured at the half-maximum of the mode (ΔD50), which is a measure of the breadth of the aggregate size distribution. For example, the acetylene black according to the present invention can have an aggregate size distribution with a D_{mode} of 50 nm or more, such as 60 nm or more, or 70 nm or more, or 80 nm or more. The acetylene black according to the present invention can for example have an aggregate size distribution with a D_{mode} of 200 nm or less, such as 150 nm or less, or 130 nm or less, or 120 nm or less. The D_{mode} can be in a range between any of the recited values such as from 50 nm to 200 nm, or from 70 nm to 150 nm. Alternatively or in addition, the aggregate size distribution of the acetylene black according to the present invention can exhibit a ratio ΔD50/D_{mode} of 0.5 or more, such as 0.6 or more, or 0.7 or more, or 0.8 or more, or 0.9 or more, or 1.0 or more, or 1.2 or more, or 1.5 or more. The aggregate size distribution of the acetylene black can for example have a ratio ΔD50/D_{mode} of up to 2.5, such as 2.2 or less, 2.0 or less, or 1.8 or less, or 1.7 or less. The ratio ΔD50/D_{mode} can be in a range between any of the recited values such as from 0.5 to 2.5, or from 1.0 to 2.0, or from 1.5 to 2.0.

The acetylene black according to the present invention can moreover be characterized by an amount of grit. Grit refers to coarse particles, which are typically undesirable as they may adversely affect application properties of the acetylene black material. The acetylene black according to the present invention can have a low amount of grit. For instance, it may have a residue not passing an ASTM sieve having a mesh opening size of 45 μm (ASTM E11-17, sieve designation: #325) of less than 100 ppm, more preferably less than 50 ppm, or less than 10 ppm, based on the total weight of the acetylene black.

In addition or alternatively, the acetylene blacks according to the present invention can exhibit a relatively high degree of crystallinity and/or proportion of graphitic domains, as can be indicated by Raman spectroscopy. Raman spectra of carbon black materials include two bands at about 1,360 cm⁻¹ and at about 1,580 cm⁻¹, denoted as “D-band” and “G-band”, respectively. The “D-band” at about 1,360 cm⁻¹ is generally attributed to disordered sp² carbon atoms, whereas the “G-band” at about 1,580 cm⁻¹ is attributed to graphitic or ordered sp² carbon atoms. The ratio of the integrated area of the “D-band” to the integrated area of the “G-band” (D/G ratio) thus provides a measure for the degree of crystallinity and/or proportion of graphitic domains, with lower values of the D/G ratio indicating a higher degree of order/crystallinity and/or a higher proportion of graphitic domains in the investigated carbon black material. The acetylene black of the present invention can exhibit a D/G ratio, as determined by Raman spectroscopy, of 1.5 or less, preferably 1.4 or less, more preferably 1.3 or less. The acetylene black of the present invention can have a D/G ratio as low as 0.8, such as 0.9 or more, or 1.0 or more. The acetylene black of the present invention can have a D/G ratio in a range between any of the recited values such as from 0.8 to 1.5, or from 0.9 to 1.4, or from 1.0 to 1.3.

In addition or alternatively, the acetylene black according to the present invention can be characterized by a crystallite size. The acetylene black can for example be characterized by an L_{c} crystallite size. The acetylene black of the present invention can for example have an L_{c} crystallite size of 26 Å or more, such as 28 Å or more, or 30 Å or more, or 32 Å or more. The acetylene black of the present invention can for example have an L_{c} crystallite size of 50 Å or less, such as 45 Å or less, or 40 Å or less, or 38 Å or less, or 35 Å or less. The acetylene black of the present invention can have an L_{c} crystallite size in a range between any of the recited values such as from 26 Å to 50 Å, or from 28 Å to 40 Å, or from 30 Å to 38 Å. Alternatively or in addition, the acetylene black of the present invention can be characterized by an Lₐ crystallite size. The acetylene black can for example have an Lₐ crystallite size of 60 Å or more, such as 65 Å or more, or 70 Å or more, or 75 Å or more. The acetylene black can for example have an Lₐ crystallite size of 100 Å or less, such as 95 Å or less, or 90 Å or less. The acetylene black of the present invention can have an Lₐ crystallite size in a range between any of the recited values such as from 60 Å to 100 Å, or from 70 Å to 90 Å. The L_{c} crystallite size and the Lₐ crystallite size can be determined by X-ray diffraction as for example described in “Self-decomposition of hydrogen peroxide on the surface of disperse carbon black”, G. I. Razdyakonova, V. A. Likholobov, Nanosystems, RENSIT, 2015, 7 (2): 180-190.

In addition or alternatively, the acetylene black of the present invention can be characterized by its chemical composition or purity, such as by one or more than one or all of the following: its carbon content, oxygen content, hydrogen content, sulfur content, nitrogen content, total metal content and/or ash content. Typically, the acetylene black has a high carbon content, being composed essentially of carbon. Thus, the acetylene black of the present invention can have a carbon content of 98.5 wt. % or more, preferably 99.0 wt. % or more, or 99.2 wt. % or more, or 99.4 wt. % or more, or 99.5 wt. % or more, or 99.6 wt. % or more, such as up to about 100 wt. %, based on the total weight of the acetylene black. The content of non-carbonaceous impurities, if any, can consequently be low. The acetylene black can for example have a hydrogen content of less than 1.0 wt. %, such as less than 0.5 wt. %, or less than 0.3 wt. %, based on the total weight of the acetylene black. The acetylene black of the present invention can have an oxygen content of less than 0.1 wt. %, such as less than 0.05 wt. %, or less than 0.03 wt. %, based on the total weight of the acetylene black. The nitrogen content of the acetylene black of the present invention can be less than 0.2 wt. %, such as less than 0.1 wt. %, based on the total weight of the acetylene black. The sulfur content of the acetylene black of the present invention can be less than 0.1 wt. %, such as less than 0.05 wt. %, or less than 0.01 wt. %, based on the total weight of the acetylene black. The carbon content, oxygen content, hydrogen content, sulfur content, nitrogen content of the acetylene black can be determined by quantitative elemental analysis. In addition or alternatively, the acetylene black of the present invention can have a low content of metals. The acetylene black can for example have a metal content of less than 1,000 ppm, such as less than 100 ppm, or less than 50 ppm, or less than 20 ppm, or less than 10 ppm, based on the total weight of the acetylene black. The metal of the acetylene black can for example be determined by inductively coupled plasma optical emission spectroscopy (ICP-OES), for instance using a Prodigy 7 instrument from TELEDYNE LEEMAN LABS, Mason, USA. Further, the acetylene black of the present invention can have an ash content of 1 wt. % or less such as 0.5 wt. % or less, or 0.2 wt. % or less, or preferably 0.1 wt. % or less, or more preferably 0.05 wt. % or less, based on the total weight of the acetylene black. The ash content can be determined according to ASTM D1506-15.

The acetylene black according to the present invention has been found to be exceptionally conductive. The acetylene black according to the present invention can for example exhibit a low powder resistivity. The powder resistivity can be determined by measuring the electrical resistance of a powder sample of the acetylene black that is subjected to compression in a chamber at defined mean geometric pressure, such as using a void-volume-tester equipped for concurrent measurement of electrical resistance as described in the examples. The acetylene black according to the present invention can for example have a powder resistivity, measured at a pressure of 50 MPa, of less than 1.0 Ω·cm, such as 0.5 Ω·cm or less, 0.3 Ω·cm or less, or 0.2 Ω·cm or less, or 0.1 Ω·cm or less, or 0.08 Ω·cm or less, or 0.06 Ω·cm or less. It can for example have a powder resistivity, measured at a pressure of 50 MPa, of 0.005 Ω·cm or more, such as 0.01 Ω·cm or more, such as 0.02 Ω·cm or more, or 0.03 Ω·cm or more. The acetylene black of the present invention can have a powder resistivity (@50 MPa) in a range between any of the recited values such as from 0.005 to 1.0 Ω·cm, or from 0.01 to 0.1 Ω·cm, or from 0.02 to 0.06 Ω·cm.

The acetylene black according to the present invention, as described herein, can be manufactured based on incomplete combustion of an acetylene-containing hydrocarbon feedstock by an oxygen-containing gas. Such an incomplete combustion reaction may be represented schematically by the following equation:

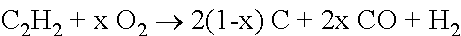

wherein x is a number greater than 0 and less than 1. As set forth above, the present invention therefore also concerns a process for manufacturing an acetylene black. The process comprises supplying a hydrocarbon feedstock comprising acetylene to a reactor, supplying an oxygen-containing gas to the reactor, effecting incomplete combustion of the hydrocarbon feedstock comprising acetylene by bringing the hydrocarbon feedstock comprising acetylene in contact with the oxygen-containing gas to thereby cause formation of the acetylene black in the reactor, and recovering the formed acetylene black. The amounts of the hydrocarbon feedstock comprising acetylene and the oxygen-containing gas introduced into the reactor are controlled such that the molar ratio of oxygen to acetylene [denoted by x in the above equation] is in a range from 0.30 to 0.80. Preferably, the molar ratio of oxygen to acetylene can be in a range from 0.30 to 0.60, more preferably from 0.32 to 0.50, such as from 0.35 to 0.45, or from 0.37 to 0.42.

The hydrocarbon feedstock used in the process according to the present invention comprises acetylene. It can optionally further comprise one or more hydrocarbons other than acetylene. Such optional additional hydrocarbons can be exemplified, without being limited thereto, by ethylenically unsaturated hydrocarbons such as alkylenes like ethylene or propylene, aromatic hydrocarbons such as benzene, toluene or xylene, and aliphatic hydrocarbons such as alkanes like methane, ethane or propane, or mixtures or combinations of any of the foregoing. Typically, the hydrocarbon feedstock comprises at least 50 wt. %, such as 70 wt. % or more, or 80 wt. % or more, or 90 wt. % or more, or 95 wt. % or more, or 98 wt. % or more, or 99 wt. % or more of acetylene, based on the total weight of the hydrocarbon feedstock. Preferably, the hydrocarbon feedstock consists of acetylene. For the sake of clarity, a hydrocarbon feedstock consisting of acetylene can still contain impurities as are ubiquitous in technical acetylene gas, such as impurities in a total amount of up to 2 wt. %, based on the total weight of the hydrocarbon feedstock. Acetylene from an acetylene recovery unit from a steam cracker is typically received with a purity of ≥99 wt. %. The acetylene-containing hydrocarbon feedstock is typically supplied to the reactor in gaseous form. Optionally, the hydrocarbon feedstock can be preheated before being brought into contact with the oxygen-containing gas. If preheated, the acetylene-containing hydrocarbon feedstock is usually preheated to a temperature of 150° C. or less, for reasons of security.

As oxygen-containing gas any oxygen-containing gas can be used such as, without being limited thereto, air, oxygen-enriched air, nitrogen-enriched air, oxygen-containing technical gas mixtures, such as tail gas from carbon black production, or oxygen gas itself. The oxygen-containing gas can for example contain oxygen in an amount of 1 vol. % or more, or 5 vol. % or more, such as 10 vol. % or more, or 15 vol. % or more, or 20 vol. % or more, based on the total volume of the oxygen-containing gas. The oxygen-containing gas can for example contain oxygen in an amount of up to 100 vol. %, such as 99 vol. % or less, or 95 vol. % or less, or 90 vol. % or less, or 80 vol. % or less, or 60 vol. % or less, or 50 vol. % or less, or 40 vol. % or less, or 30 vol. % or less, based on the total volume of the oxygen-containing gas. The oxygen-containing gas can have an oxygen content in a range between any of the recited values such as from 1 vol. % to 100 vol. %, such as from 10 vol. % to 80 vol. %, or from 20 vol. % to 30 vol. %, based on the total volume of the oxygen-containing gas. For economic reasons, air is preferably used as the oxygen-containing gas in the process according to the present invention. The oxygen-containing gas can optionally be preheated before being brought into contact with the hydrocarbon feedstock. For instance, the oxygen-containing gas can be preheated to a temperature of 200° C. or more, such as 300° C. or more, or 500° C. or more, or 700° C. or more. For practical reasons, the oxygen-containing gas is typically not preheated to temperatures above 850° C.

The oxygen-containing gas and the hydrocarbon feedstock, optionally after being preheated, are supplied, by introducing means, such as a burner, to a reactor where they are brought into contact with each other for effecting incomplete combustion of the hydrocarbon feedstock to thereby cause formation of the acetylene black in the reactor as is described for example in U.S. Pat. No. 4,013,759. In the method disclosed herein, the rates with which the oxygen-containing gas and the hydrocarbon feedstock are supplied to the reactor are generally controlled such that the molar ratio of oxygen to acetylene is in the above-indicated range. The rates with which the oxygen-containing gas and the hydrocarbon feedstock are supplied to the reactor can for example independently each individually be in a range from 5 to 500 Nm³/h, such as from 10 to 300 Nm³/h, or from 20 to 200 Nm³/h, or from 30 to 150 Nm³/h. By the incomplete combustion of the hydrocarbon feedstock high temperatures on the order of 2,000° C. can be reached inside the reactor. Typically, the acetylene black is formed at a temperature of at least 1,700° C., such as 1,800° C. or more, or 1,900° C. or more, or 2,000° C. or more in the reactor.

The pressure in the reactor may be controlled in operation for safety and process control reasons. The pressure in the reactor can for example be above atmospheric pressure (101.3 kPa) such as to prevent air ingress. For example, the pressure in the reactor can be in a range from 0.01 to 1 MPa above atmospheric pressure. Alternatively, it is also possible that the reactor is operated under a vacuum, that is at a pressure below atmospheric pressure, for example at a pressure in a range from 1 to 100 kPa.

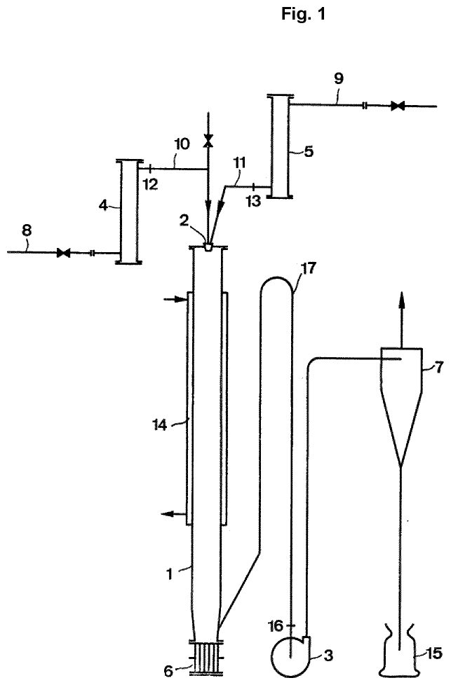

The process for manufacturing the acetylene blacks according to the present invention can be carried out in a reactor as schematically depicted in FIG. 1. The reactor comprises a vertical furnace (1). The vertical furnace (1) can for example be a vertical cylindrical furnace having a total height of 7.4 m and an internal diameter of 300 mm. A burner (2) is provided at the upper part of the vertical furnace. Oxygen-containing gas, such as air, can be supplied from a source (not shown) via feed line (9) to an optional preheater (5), where it can optionally be preheated, and is then passed to the burner (2) through line (11). The acetylene-containing hydrocarbon feedstock can be supplied from a source (not shown) via feed line (8) to an optional preheater (4), where it can optionally be preheated, and is then passed to the burner (2) through line (10). Optionally, means for measuring the temperature of the oxygen-containing gas (13) and the hydrocarbon feedstock (12), respectively, supplied to the burner can be provided. In operation, the oxygen-containing gas and the hydrocarbon feedstock are introduced into the vertical furnace (1) by the burner (2). The amounts of the oxygen-containing gas and the hydrocarbon feedstock are regulated so that the molar ratio of oxygen to acetylene has the desired value. The burner (2) can be structured such that a stream of the oxygen-containing gas is introduced into the furnace (1) in a zone immediately adjacent to the zone of introduction of a stream of the hydrocarbon feedstock, such as at the periphery thereof and approximately tangentially thereto. The burner (2) can for example comprise an axial nozzle provided with a cylindrical internal channel for the introduction of the acetylene-containing hydrocarbon feedstock which is surrounded by a hollow annular zone for introduction of the oxygen-containing gas. Such a burner is described in more detail for example in U.S. Pat. No. 4,013,759. The burner can comprise cooling means, such as water cooling of the acetylene inlet tube, which can minimize acetylene polymerization and thereby coking, as e.g. described in the dissertation entitled “The production of carbon black by the thermal decomposition of acetylene and acetylene-hydrocarbon mixtures” of E. J. Claassen Jr., Austin, Texas, May 1948. Incomplete combustion of the hydrocarbon feedstock occurs in a combustion zone in the upper part of the vertical furnace (1). Unwanted coking can be delayed by pre-mixing the acetylene with hydrogen and/or ensuring a sharp jet of acetylene from the burner nozzle, as also described in the above-mentioned dissertation of E. J. Claassen. The walls of the vertical furnace or portions thereof, e.g. in the upper part of the furnace, may be protected against the high temperatures occurring inside the furnace by having an internal lining of a refractory material such as graphite and/or being provided with cooling means such as a water-cooled jacket (14). Thus, it may also be possible to increase the reaction temperature and/or the yield. A pressure gradient is created within the furnace by means of a pump or ventilator (3). The aerosol formed by the reaction containing formed acetylene black particles and residual gases is withdrawn in the lower part of the vertical furnace (1) through circuit (17), along which the aerosol is cooled by natural convection. Means for measuring the temperature of the aerosol (16) withdrawn from the vertical furnace may be installed along the circuit (17). The cooled aerosol is directed through the circuit (17) to one or more separation cyclone(s) (7) for separating the formed acetylene black from the gases of the aerosol. The separated acetylene black is then collected in a vessel such as a hopper (15), whereas the gases separated by the cyclone(s) are exhausted.

In operation, the stream of hydrocarbon feedstock may be interrupted from time to time for a short period (e.g. a few seconds to a minute) and during this interruption, a stream of pressurized gas, e.g. compressed air, be sent into the furnace to detach carbon black which may have become deposited on the burner or furnace walls. A disintegrating mill (6) can be provided at the bottom of the vertical furnace for breaking agglomerates of carbon black, which may detach from the burner or furnace walls.

From time to time (e.g. days to weeks) the reactor may be taken out of production for short time and cleaned, when cooled down. This cleaning removes all deposits and is more intensive then the previously described in operation cleaning. The cleaning can be achieved by high pressure air, brushes, ultrasonic cleaning devices and other commonly known cleaning aids.

Optionally, the reactor may further comprise means for separating grit from the aerosol such as a wire grid filter, made from a material withstanding the high operating temperatures, e.g. nickel-based alloys. As a further option, the reactor may comprise one or more purifying means, e.g. magnetic filters, for removing impurities such as metals or metal-rich particles from the aerosol. The optional means for separating grit and/or purifying means can be provided for example along circuit (17).

The acetylene black formed according to the above-described manufacturing process present is typically obtained in the form of a fluffy powder. The as-obtained powder can be subjected to further processing, if desired, such as size classification (e.g. by using sieves) and/or densification. For example, the as-obtained acetylene black in the form of a fluffy powder can be densified to form compacted entities derivable therefrom such as pellets, granules or alike. Densifying may be carried out by any method known in the art for densifying pulverulent materials such as, without being limited thereto, application of vacuum, pressing, rolling, pelletizing, granulation, briquetting or a combination thereof. Densifying the acetylene black can be carried out using conventional technologies and equipment including for example fluid bed spray granulation, fluidized spray drying, agitation granulation, dry pelletizing, wet pelletizing or a combination thereof. Pelletizing of the initial acetylene black can for example be carried out as described in EP 2 913 368 B1. The acetylene black can optionally further be subjected to drying, particularly when the acetylene black has been contacted with a wet medium, for instance in a wet pelletizing step. Drying can be carried out by drying means commonly used in the art such as by applying heat and/or a vacuum. For example, the acetylene black can be dried such that the residual moisture content of the acetylene black, e.g. densified acetylene black, after drying is less than 0.1 wt. %, such as less than 0.05 wt. %, based on the total weight of the acetylene black. The moisture content can be determined according to ASTM D1509-95.

The acetylene blacks according to the present invention, which can be obtained for example as described above, can be utilized in various technical applications, including all kinds of applications where acetylene blacks are typically used. For application, the acetylene blacks can be compounded with one or more other components such as a binder and/or a solvent, as described in more detail below. The present invention thus also concerns compositions comprising the acetylene black described herein. Herein, the acetylene black according to the present invention can impart exceptionally high electrical and/or thermal conductivity to a composition or article made therefrom and/or allow imparting thereto a desired level of electrical and/or thermal conductivity at a comparatively low concentration of acetylene black.

The acetylene black of the present invention can advantageously be processed using common powder processing technology and equipment and can be readily formulated into compositions. The composition can for example be provided in the form of a dispersion, a dry powder, a paste or a solid mass. The acetylene black material according to the present invention can for instance be compounded with or dispersed in a carrier medium, such as an aqueous or organic solvent-based carrier medium or a plastic material. For this purpose, common mixing and blending equipment e.g., blenders, mixers, kneaders, single- or twin-screw extruders can be used. The acetylene black according to the present invention typically exhibits good dispersibility various carrier media, and yields compositions with adequate and stable processing and application properties. The amounts in which the pulverulent acetylene black material is used depend significantly on the type of composition and intended application and can be selected by the skilled artisan according to the respective needs based on similar formulations with conventional acetylene blacks.

As used herein an aqueous carrier medium refers to a carrier medium that includes more than 50 wt. %, such as 70 wt. % or more, or 80 wt. % or more, or 90 wt. % or more, or up to 100 wt. %, of water, based on the total weight of the carrier medium. An organic solvent-based carrier medium refers to a carrier medium that includes more than 50 wt. %, such as 70 wt. % or more, or 80 wt. % or more, or 90 wt. % or more, or up to 100 wt. %, of organic solvent(s), based on the total weight of the carrier medium. The kind of carrier medium used depends on the respective type of application and may vary widely. The carrier medium may comprise water and/or one or more organic solvent(s). Organic solvents that may be used include for example, without being limited thereto, alcohols, ketones, aldehydes, amines, esters, ethers, carboxylic acids, hydrocarbons, or mixtures or combinations thereof.

Similarly, all types of polymer or resin materials can be used as plastic material or binder in compositions according to the present invention, depending on the intended application. Non-limiting examples of useful resins and polymers that can be employed according to the present invention include olefinic polymers such as polypropylene, polyethylene, ethylene-vinyl acetate copolymers, ethylene-vinyl alcohol resins, cyclic olefin copolymers, rubbers such as natural rubber, styrene butadiene rubber, acrylonitrile butadiene rubber, butyl rubber, acryl rubber, ethylene-propylene rubber, ethylene-propylene terpolymer, ethylene-a-olefin copolymer rubber, silicone rubber, fluoro rubber, chloroprene rubber, hydrin rubber, and chlorosulfonated polyethylene rubber, vinyl chloride-type polymers such as polyvinyl chloride and ethylene vinyl chloride copolymers, styrene-type polymers such as polystyrene, styrene-acrylonitrile copolymers and acrylonitrile-butadiene-styrene copolymers, acrylic polymers such as polymethyl methacrylate, polyesters such as polyethylene terephthalate, polybutylene terephthalate, polyamides, polyacetales, polycarbonates, polyphenylene ethers, fluoropolymers such as polytetrafluoroethylene and polyvinylidine fluoride, polyphenyline sulfides, liquid crystal polymers, thermoplastic polyamides, ketone-type resins, sulfonic resins, phenyl resins, urea resins, melamine resins, alkyd resins, silicone resins, epoxy resins, urethane resins, polyvinyl esters, polyimides, furan resins, quinine resins, as well as mixtures, blends or combinations thereof. The present invention thus relates also to rubber or plastic compositions comprising an acetylene black as disclosed herein and a rubber or polymer, such as a rubber or polymer as described above. It also relates to rubber and plastic articles made from such a rubber or plastic composition.

Depending on the type of application, further ingredients can be used in formulating the compositions according to the present invention. The skilled artisan will select such optional further ingredients and their respective amounts in accordance with the desired properties and/or application of the composition. Illustrative examples of such further ingredients include for instance oils and waxes, processing aids, rheology modifiers, pH modifiers, fillers, pigments, dyes, coupling agents, catalysts, accelerators, vulcanizing agents, activators, sulfur curatives, antidegradants, antioxidants, stabilizers, biocides, and plasticizers. As described in more detail below, the compositions according to the present invention are for instance useful for electrochemical applications like battery applications. For such applications they may accordingly further comprise one or more electrochemically active ingredient. The electrochemically active ingredient can for instance be a common anode material or cathode material or electrocatalyst.

As will be appreciated, the acetylene black according to the invention and compositions containing the same and articles made therefrom may particularly be used in applications where high electrical and/or thermal conductivity is desired or beneficial. The acetylene black material of the present invention can for example impart electrical conductivity to compositions containing the same and articles manufactured therefrom. Thus, the acetylene carbon black material of the present invention is particularly useful for instance for electrodes, conductive catalyst supports and electrical conductors, including high voltage cables, and for power and battery applications, including primary batteries, secondary batteries, fuel cells and capacitors. Accordingly, the present invention is also directed towards an electrode or other component of an energy storage and/or conversion device made from the acetylene black or the present invention or a composition comprising the same. The present invention likewise concerns an energy storage and/or conversion device comprising such an electrode or component. The energy storage and/or conversion device can for example be a primary battery, a secondary battery, a fuel cell or a capacitor. The acetylene black material of the present invention and compositions containing the same and articles made therefrom can moreover be used as or for the production of heat conductive materials or heat transfer materials.

Furthermore, the acetylene black material may also be used as an antistatic agent or as an electrically conductive agent, for instance in rubber or plastic materials and articles such as bladders for the production of tires.

The acetylene black as disclosed herein can for example be used as an electrically conductive agent, antistatic agent, thermally conductive agent, reinforcing filler and/or coloring agent, for example for a production of electrodes and other components of energy storage and/or conversion devices such as primary batteries, secondary batteries, fuel cells and capacitors, and/or of plastic articles made of a thermoplastic or thermoset polymer or rubber matrix such as tires or components thereof, wires, cables and sheaths thereof, belts, hoses, shoe soles, rollers, heaters, or bladders, such as tire bladders, heat conductive materials, heat transfer materials, and/or in coatings, paints or inks.

Having generally described the present invention above, a further understanding can be obtained by reference to the following specific examples. These examples are provided herein for purposes of illustration only, and are not intended to limit the present invention, which is rather to be given the full scope of the appended claims including any equivalents thereof.

### EXAMPLES

### Preparation of Acetylene Blacks

Acetylene blacks were produced in a reactor as described above, which is schematically depicted in FIG. 1 of the present application. The reactor includes a vertical furnace (1) with a burner (2) extending at its top end into the furnace. Acetylene and air were supplied to the axial nozzle of the burner via supply lines (8) and (9), respectively. A preheater (5) was installed in the air supply line to preheat the air feed. No preheater (4) was used in the acetylene supply line. Incomplete combustion of the supplied acetylene by the supplied air occurred in the vertical furnace, resulting in the formation of the acetylene black. The walls of the furnace were protected against the high temperatures in the inside of the furnace by a double water-cooled jacket (14). A ventilator (3) in fluid connection to the lower portion of the furnace created a lowering of pressure within the furnace to prevent occlusion of the burner and direct the formed aerosol containing the acetylene black via circuit (17), where it cooled due to natural convection, to a set of cyclones (7), where the acetylene black was separated from the gases and collected in a vessel.

### Example 1

An acetylene black was produced using the above-described reactor introducing 42 Nm³/h of acetylene (not preheated) and 75 Nm³/h of air, preheated to a temperature of 300° C., into the vertical furnace by way of the burner. Every 60 minutes the stream of acetylene was interrupted and an approximately 2 min long cleaning cycle employing air at ordinary temperature compressed to 2 bars initiated. Then the current of acetylene was started again. The thus obtained acetylene black was collected in the hopper (15) of the reactor. The stoichiometrical yield was 58%.

### Example 2 (Comparative Example)

Another acetylene black was produced using the above-described reactor. The operation was conducted as in Example 1, but introducing 55 Nm³/h of acetylene (not preheated) and 75 Nm³/h of air, preheated to a temperature of 300° C., into the vertical furnace by way of the burner. Every 60 minutes the stream of acetylene was interrupted and an approximately 2 min long cleaning cycle employing air at ordinary temperature compressed to 2 bars initiated. Then the current of acetylene was started again. The thus obtained acetylene black was collected in the hopper (15) of the reactor. The stoichiometrical yield was 66%.

### Properties of the Acetylene Blacks

Properties of the acetylene blacks obtained according to Examples 1 and 2 as determined by the characterization methods set forth below are summarized in Table 1 in comparison to acetylene black commercially available under the tradename ‘Li-435’ from Denka Co. Ltd., used in the art as conductive agent, as a reference material.

As it can be seen from Table 1, the acetylene black material according to the present invention (Example 1) had inter alia a significantly higher structure (indicated by the higher OAN and void volume) and exhibited a significantly lower volume resistivity, i.e. higher electrical conductivity, than the comparative acetylene black material according to Example 2 or the commercial reference material Li-435.

TABLE 1
Properties of the acetylene blacks

| | | | Example 2 | Li-435 |
|---|---|---|---|---|
| | | Example 1 | (Comp. Ex.) | (Comp. Ex.) |
| OAN | [mL/100 g] | 420 | 350 | 330 |
| BET specific | [m²/g] | 132 | 113 | 130 |
| surface area | | | | |
| Avg. primary | nm | 20.8 | 21.1 | 18.7 |
| particle size | | | | |
| (TEM image | | | | |
| analysis) | | | | |
| Crystallite | nm | 3.3 | 3.3 | 2.6 |
| size L_{c} | | | | |
| Crystallite | nm | 8.0 | 9.2 | 6.2 |
| size Lₐ | | | | |
| Raman | — | 1.25 | 1.24 | 1.36 |
| (D/G) ratio | | | | |
| D_{mode} (ASD | nm | 83 | 90 | 89 |
| by DCP analysis) | | | | |
| ΔD50/D_{mode} | | 1.7 | 1.4 | 1.4 |
| (ASD by DCP | | | | |
| analysis) | | | | |
| Carbon content | [%] | 99.62 | 99.64 | 99.60 |
| Hydrogen content | [%] | 0.28 | 0.26 | 0.34 |
| Oxygen content | [%] | 0.01 | 0.01 | 0.03 |
| Nitrogen content | [%] | 0.07 | 0.06 | 0.03 |
| Sulphur content | [%] | 0.00 | 0.00 | 0.00 |
| Void volume | [cm³/100 g] | 81.7 | 72.0 | 71.4 |
| (@50 MPa) | | | | |
| Void volume | [cm³/100 g] | 67.9 | 60.2 | 59.3 |
| (@75 MPa) | | | | |
| Void volume | [cm³/100 g] | 52.4 | 46.9 | 45.8 |
| (@125 MPa) | | | | |
| Resistivity | [Ω · cm] | 0.058 | 0.061 | 0.070 |
| (@50 MPa) | | | | |

The BET specific surface area was measured by nitrogen adsorption in accordance with ASTM D6556-19a. The applied pressure points were 0.05, 0.075 and 0.1 p/p⁰. The used mass of the sample was in a range from 0.15 to 0.4 g. The pulverulent carbon black samples were compressed before the BET analysis. To this end, 5 g of the pulverulent carbon black sample were added into a paper bag. The closed paper bag was then inserted into a plastic zip bag. The zip bag was then closed, leaving a small opening, where a fitting tube connected to a vacuum pump was inserted. The vacuum pump was then switched on and the tube was positioned at the edge of the paper bag in the plastic zip bag. The zip bag was then tightly closed and enclosed air pockets were manually removed. Compression was then carried out for further 60 seconds under vacuum. The vacuum was then switched off and the compressed carbon black sample retrieved from the paper bag.

The oil absorption number (OAN) was measured according to ASTM D2414-19 procedure B. The used mass of the carbon black sample was in a range from 6 to 12 g.

The carbon content, hydrogen content, oxygen content, nitrogen content and sulfur content were determined by quantitative elemental analysis using an automated elemental analyser (vario EL cube elemental analyser from Elementar Analysensysteme GmbH) following DIN 51732-2014-07. The acetylene black material to be analyzed was dried for 2 h at 125° C. before conducting the quantitative elemental analysis.

The acetylene blacks were investigated for their particle size, shape and morphology by TEM analysis. 20 mg of the acetylene black material to be analyzed were transferred into a 5 mL polyethylene lab tube and dispersed in 2 mL chloroform for 3 minutes in an ultrasonic bath using an ultrasonic stick immersed into the bath and operated at a power of 100 W to provide a good dispersion of the acetylene black powder. Afterwards, a single drop of the dispersion was transferred with an Eppendorf microliter pipette onto a carbon-coated copper TEM holder (200 mesh). The loaded grid was then transferred into the high vacuum of a TEM instrument (Hitachi H-7500, 100 kV) and investigated. The average primary particle size was determined from a set of representative TEM images containing about 2,000 well-dispersed isolated particles by automated image analysis according to ASTM D3849-07.

The aggregate size distribution was further determined by means of disk centrifuge photosedimentometry (DCP) according to ISO 15825:2017 for the investigated acetylene blacks, using a Brookhaven BI-DCP Particle Size Analyzer.

The acetylene black materials were further analyzed by Raman spectroscopy. For this purpose, a sample of powder of the acetylene black material to be analyzed was put on a glass slide for microscopes and flattened by manually pressing gently from the top with a second glass slide. Raman spectra were then recorded for the thus prepared sample using a Thermo Scientific DXR Raman Microscope (Thermo Fisher Scientific) with 50× magnification and a power of 0.5 mW of the laser operating at a wavelength of 532 nm for an acquisition time of 2 seconds and an exposure rate of 32. Measurements were taken at 10 different positions for each sample to check for reproducibility. By peak fitting analysis the intensities of the defect band (D-band) at about 1,360 cm⁻¹ and of the graphite band (G-band) at about 1,580 cm⁻¹ were determined from the recorded Raman spectra. The reported (D/G) ratio corresponds to the arithmetic average of the ratio of the intensity of the D-band to the intensity of the G-band over the conducted ten measurements. A lower value of the (D/G) ratio indicates a relatively higher proportion of graphitic domains, i.e. higher degree of order/crystallinity.

The acetylene black materials were moreover analyzed by X-ray diffraction (XRD) to determine their crystallite sizes Lₐ, L_{c}, using the procedure described in “Self-decomposition of hydrogen peroxide on the surface of disperse carbon black”, G. I. Razdyakonova, V. A. Likholobov, Nanosystems, RENSIT, 2015, 7 (2): 180-190.

The void volume was determined based on ASTM D7854-18a. To this end, a sample of the acetylene black to be analyzed was provided on a tray and dried for at least one hour in a convection oven set at 125±5° C. The dried material was then cooled to ambient temperature and stored in a desiccator before use. Using a scale, 1.000 g of the sample were weighed to the nearest 0.1 mg into a sample pan. The weighed sample was then transferred into the cylindrical sample chamber (1 inch diameter) of a void-volume-tester (CVST of HITEC, Luxembourg) using a funnel. The sample pan and funnel were carefully brushed to ensure that the entire sample was introduced into the cylindrical sample chamber. The cylindrical sample chamber was then closed and the test started by applying pressure to the movable piston of the cylindrical sample chamber, measuring the compressed volume of the weighed sample in the cylindrical chamber as a function of the pressure exerted by the movable piston. The pressure was ramped from 0 to 125 MPa geometric mean pressure and subsequently back from 125 to 0 MPa geometric mean pressure with a compression/decompression rate of 2 MPa/s. Both the compression and the decompression curve were recorded and the void volume calculated from the measured volume as a function of the pressure exerted by the movable piston and the weight of the sample. The values reported in Table 1 corresponds to the arithmetic average of the void volume determined at a geometric mean pressure of 50 MPa, 75 MPa or 125 MPa, respectively, from the compression and the decompression curve.

The powder resistivity of the acetylene blacks was measured concurrently in the above-described void volume testing using the void-volume-tester (CVST of HITEC Luxembourg) with ceramic cylindrical sample chamber in accordance with manufacturer instructions. The electrical resistance of the analyzed sample was recorded over both the compression and the decompression scan as a function of the pressure exerted by the movable piston and the resistivity calculated therefrom. The value reported in Table 1 corresponds to the arithmetic average of the resistivity determined at a geometric mean pressure of 50 MPa from the compression and the decompression curve.

### Preparation of Electrode Slurry

A dry premix was prepared by adding 4.5 g Solef 5130 (Solvay) PVDF polymer, 291 g Lithium-Nickel-Manganese-Cobalt-Oxide NMC 532 (BASF), and 4.5 g of either the acetylene black according to Example 1 or Li-435 to the mixing vessel of a double-planetary mixer (FMPE HM2P-03 from Bühler Technologies GmbH, Ratingen, Germany). The dry composition was mixed for 15 min in the double-planetary mixer at a speed of 20 rpm at room temperature.

Next, the premix was dispersed in an organic solvent in a two-step procedure. At first, 80 g N-Methyl-2-pyrrolidon (NMP, analytical purity ≥99.5% provided by VWR chemicals) and 1.125 g dispersing agent (BYK 40% LPN24711) were added to the respective premix and then mixed in the double-planetary mixer for 10 min at 40 rpm followed by 50 min at 80 rpm. Subsequently, additional 15 g NMP were added to the mixture and the composition mixed for another 20 min at 80 rpm in the double-planetary mixer to obtain an electrode slurry. Fineness of the slurry as measured with a Hagman gauge was each below 20 μm.

### Preparation of Electrode Films and Measurement of Electrical Resistivity

Electrode films were prepared from the prepared electrode slurries within 4 hours of their preparation. Cathode films were prepared according to the following procedure: A 20 μm thick aluminum foil used as current collector was placed smoothly and tightly on the coater (K control coater from TQC Sheen). The respective electrode slurry was then casted onto one side of the aluminum foil and the thickness of the layer adjusted using the coater's doctor blade with a gap of 200 μm. The coated electrodes were then dried for 3 hours at 100° C. in a vacuum oven.

The electrical resistance of the thus obtained electrode films was measured with a HIOKI 4-terminal probe of an RM 3543-01 resistance HiTESTER from HIOKI. To this end, the respective coated aluminum foil was cut into a disc shape having a diameter of 14 mm and the front and back surfaces were sandwiched and centered between two flat plated metering electrodes (diameter: 10 mm, area: 0.7854 cm²). Pre-inspection during device warm-up and zero calibration using a copper disc was done. The measurement range was set to 1000 mΩ. A resistance value was automatically read from the HIOKI device after 40 seconds conditioning under the applied pressure of 0.4 MPa. Volume resistivity was calculated by multiplying the obtained resistance value with the measured area of the plated metering electrodes (0.7854 cm²) and dividing by the measured thickness of the electrode coating. The tabulated results as shown in Table 2 below represent the arithmetic average of 6 disc samples from the same respective coating.

TABLE 2
Average electrode volume resistivity for electrodes prepared
from electrode slurries containing different acetylene blacks

| Acetylene Black | Acetylene Black | Li-435 |
|---|---|---|
| material used | according to | (Comparative |
| in electrode | Example 1 | Example) |
| volume resistivity | 142 | 175 |
| [Ω · cm] | | |

As it can be seen from Table 2, the electrode formed from the slurry containing the acetylene black material according to the present invention (Example 1) exhibited a significantly lower volume resistivity than the electrodes derived from the commercial reference material Li-435.

1. An acetylene black having (a) an oil absorption number (OAN) measured according to ASTM D2414-19 of 360 mL/100 g or more and (b) a BET surface area measured according to ASTM D6556-19a in a range from 50 to 200 m²/g.

2. The acetylene black according to claim 1, wherein the acetylene black has an OAN of 380 mL/100 g or more.

3. The acetylene black according to claim 1, wherein the acetylene black has a BET surface area in a range from 80 to 160 m²/g.

4. The acetylene black according to claim 1, wherein the acetylene black has an L_{c} crystallite size as determined by X-ray diffraction of 26 Å or more, and/or has an Lₐ crystallite size as determined by X-ray diffraction of 60 Å or more.

5. The acetylene black according to claim 1, wherein the acetylene back has a D/G ratio as determined by Raman spectroscopy of less than 1.5.

6. The acetylene black according to claim 1, wherein the acetylene back has an aggregate size distribution with a D_{mode} in a range from 50 nm to 200 nm, and/or a ratio ΔD50/D_{mode} in a range from 0.5 to 2.5.

7. The acetylene black according to claim 1, wherein the acetylene black has one or more than one or all of the following:
a carbon content of at least 99.0 wt. %,
an oxygen content of less than 0.1 wt. %,
a hydrogen content of less than 0.5 wt. %,
a sulfur content of less than 0.1 wt. %,
a nitrogen content of less than 0.2 wt. %, and
a metal content of less than 1,000 ppm.

8. The acetylene black according to claim 1, wherein the acetylene black has a void volume, measured according to ASTM D7854-18a, at a pressure of 50 MPa, of 70 cm³/100 g or more, and/or has a powder resistivity, measured at a pressure of 50 MPa, of less than 0.1 Ω·cm.

9. A process for manufacturing an acetylene black according claim 1, the process comprising:
supplying a hydrocarbon feedstock comprising acetylene to a reactor,
supplying an oxygen-containing gas to the reactor,
effecting incomplete combustion of the hydrocarbon feedstock comprising acetylene by bringing the hydrocarbon feedstock comprising acetylene in contact with the oxygen-containing gas to thereby cause formation of the acetylene black in the reactor, and
recovering the formed acetylene black,
wherein the hydrocarbon feedstock comprising acetylene and the oxygen-containing gas are introduced into the reactor such that the molar ratio of oxygen to acetylene is in a range from 0.30 to 0.80.

10. A composition comprising an acetylene black according to claim 1.

11. The composition according to claim 10, further comprising at least one of an electrochemically active ingredient, a binder, and a solvent.

12. An electrode or other component of an energy storage and/or conversion device made from the acetylene black having (a) an oil absorption number (OAN) measured according to ASTM D2414-19 of 360 mL/100 g or more and (b) a BET surface area measured according to ASTM D6556-19a in a range from 50 to 200 m²/g, or from a composition comprising the acetylene black.

13. An energy storage and/or conversion device comprising an electrode or component according to claim 12.

14. A rubber or plastic article made from a composition comprising the acetylene black according to claim 1 and further at least a rubber or polymer.

15. Use of an acetylene black material according to claim 1 as an electrically conductive agent, antistatic agent, thermally conductive agent, reinforcing filler and/or coloring agent.
